(19) United States
(12) Patent Application Publication
(10) Pub. No.: US 2015/0219140 A1
(43) Pub. Date: Aug. 6, 2015

(54) METHOD FOR MANUFACTURING AN ASSEMBLY UNIT AND FASTENING UNIT FOR CARRYING OUT THE METHOD

(71) Applicant: RICHARD BERGNER VERBINDUNGSTECHNIK GMBH & CO. KG, Schwabach (DE)

(72) Inventors: RALF JENNING, WINDSBACH (DE); KLAUS ROSSMEISSL, REDNITZHEMBACH (DE); WILHELM SCHNEIDER, REDNITZHEMBACH (DE)

(21) Appl. No.: 14/607,493

(22) Filed: Jan. 28, 2015

(30) Foreign Application Priority Data
Jan. 28, 2014 (DE) 102014000924.6

(51) Int. Cl. F16B 33/00; F16B 35/04

(52) U.S. Cl. CPC F16B 33/004; F16B 35/048

(57) ABSTRACT

A method produces an assembly unit containing an assembly part having a bore and a sleeve which has a sleeve shaft. The sleeve has a terminal flange that overhangs the sleeve shaft toward the outside, and the sleeve shaft is plugged into the bore. The flange bears against the outer side of the assembly part. A gap between the sleeve and the assembly part is filled with an insulating compound. To produce the assembly unit, the sleeve shaft of a sleeve blank, the flange of which has a preassembly form such that an outer rim of the flange extends in a plane that extends at right angles to the longitudinal center axis of the sleeve shaft such that the flange underside is concave, is plugged into the bore. The sleeve blank deforms such that the insulating compound located between the flange and the assembly part is displaced into the gap.

The invention relates to a method for producing an assembly unit comprising an assembly part through which a bore passes and a sleeve which has a sleeve shaft through which a through-opening passes and a terminal flange that overhangs the sleeve shaft radially toward the outside. The sleeve shaft is arranged in the bore, i.e. it is plugged into the latter. The flange bears with its flange underside against the outer side, facing said flange, of the assembly part. In order to fix the assembly part, or the assembly unit, to another component, for example a structural element of a motor vehicle, a fastener having a head and a shank, generally a bolt, is plugged through the through-opening by way of the shank, wherein the latter has a fixing portion in the form for example of a thread, said fixing portion being fixable in a counterbore in the component. Furthermore, the invention relates to a fastener unit, consisting of the fastener and a sleeve, for carrying out said production method.

In assembly units of the present type, the joint present between the sleeve and the assembly part, to be more precise between the circumferential surface of the sleeve shaft and the wall of the bore, and between the flange and the outer side of the assembly part is frequently filled with an insulating compound. The purpose of this measure is for example to prevent the penetration of electrolytes that promote corrosion and to prevent direct contact between the sleeve and assembly part. In particular, assembly parts made of CFRP, that is to say carbon-fiber reinforced plastics, have a high potential for corrosion with respect to baser metals or metal alloys such as steel or aluminum.

It would, then, be conceivable, in order to produce assembly parts of the type in question, to use sleeves in which the flange underside and the circumferential surface of the sleeve shaft are coated with an insulating compound. However, when such a sleeve is plugged into the bore in an assembly part, there would be the risk of the coating of the sleeve shaft being partially scraped off by the often sharp-edged transition between the bore rim and the wall of the bore. Also, it would scarcely be possible to prevent the coating from being damaged during storage, transport and handling of the sleeves.

Proceeding therefrom, it is the object of the invention to propose a method for producing an assembly unit, said method providing a remedy with respect to the outlined problem. Furthermore, a further object of the invention is to specify a fastener unit consisting of fastener and sleeve, with which the method can be carried out in a simple manner.

The object is achieved according to claim 1 with regard to the method and according to claim 13 with regard to the fastener unit. In the method according to the invention, provision is made of a sleeve blank, the flange of which has a preassembly form. This differs from the form of the sleeve of the assembly unit in that the flange outer periphery, assigned to the flange underside, extends in a plane that extends at right angles to the longitudinal center axis of the sleeve shaft, wherein, however, the flange underside does not extend in this plane but is configured in a concave manner. If, thus, the flange of the sleeve blank bears against the outer side of the assembly part, a receiving space is formed between the latter and the flange, a store of flowable insulating compound being arranged in said receiving space. The store can either be applied to the bore rim before the sleeve blank is plugged into the bore, or is preferably applied to the flange underside of the flange of the sleeve blank, for instance by means of a cohesive connection. The size of the receiving space can be varied by a corresponding concavity of the flange underside such that at least a quantity of insulating compound sufficient for completely filling the joint is available. When the insulating compound store is applied to the sleeve blank, the concave cavity of the flange underside provides a degree of protection for the insulating compound store from damage, for example during transport.

If a sleeve blank of the described configuration is plugged into the bore in the assembly part in an introduction direction, the outer rim of the flange bears against the outer side of the assembly part. If a force is now applied to the sleeve blank in the introduction direction, the flange is pressed against the outer side of the assembly part with plastic deformation and at least partial elimination of the concavity of the flange underside, and in the process the insulating compound is displaced into the joint between the sleeve and assembly part. In this case, the flange outer rim, pressed against the outer side of the assembly part as a result of the application of force in the introduction direction, ensures that, on account of the relatively great flow resistance present in the region of the outer rim, the insulating compound is displaced reliably into the joint, in particular the joint portion present between the sleeve shaft and the assembly part. On account of the sealing of the flange-side joint, the displacement of the insulating compound into the joint between the sleeve shaft and bore wall is successful even when the joint is relatively narrow. This is the case for instance when the bore wall and the circumferential surface of the sleeve shaft are cylindrical and have a small difference in diameter.

The invention is now explained in more detail with reference to the appended drawings which, unless specified otherwise, are sectional illustrations.

In the drawings:

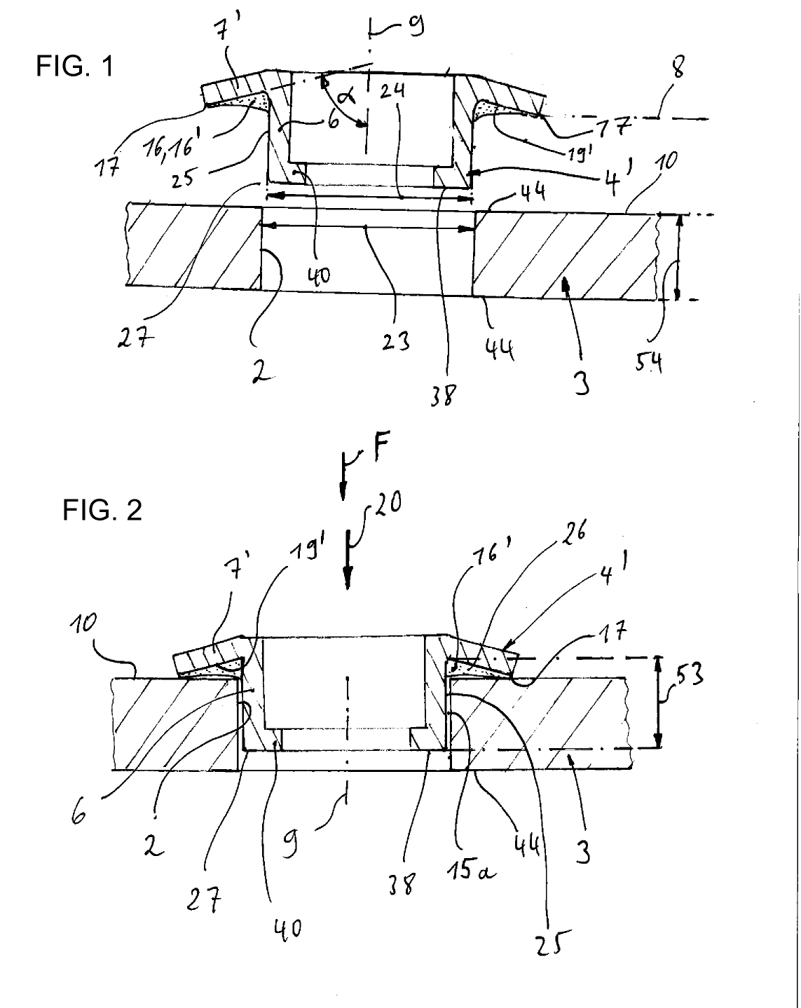

FIGS. 1-3 show schematic depictions which illustrate the method steps in the production of an assembly unit comprising an assembly part and a sleeve,

FIG. 4 shows a fastener unit formed from a sleeve and a fastener, wherein the fastener is shown in plan view,

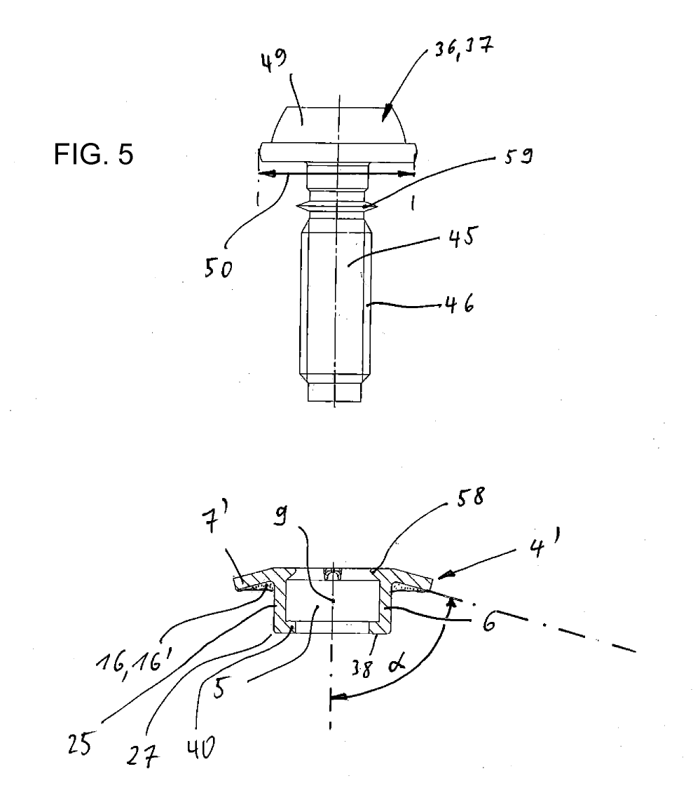

FIG. 5 shows an exploded illustration of the individual parts of the fastener unit from FIG. 4,

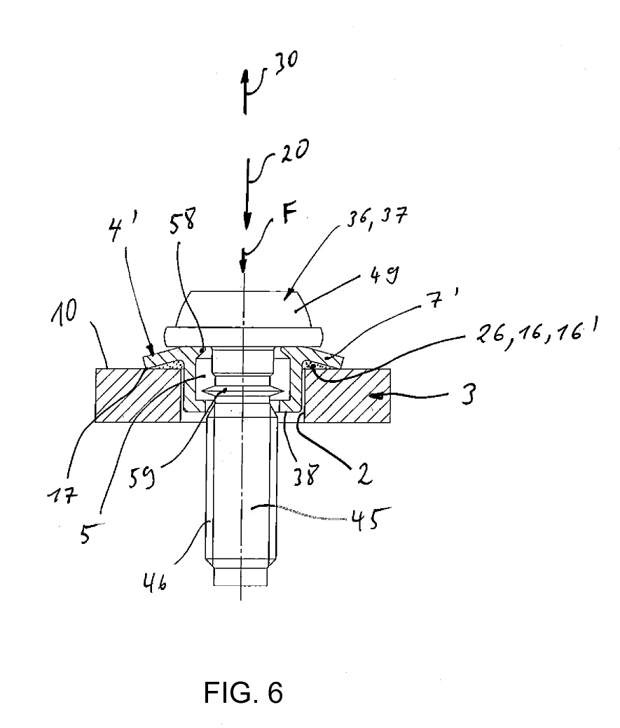

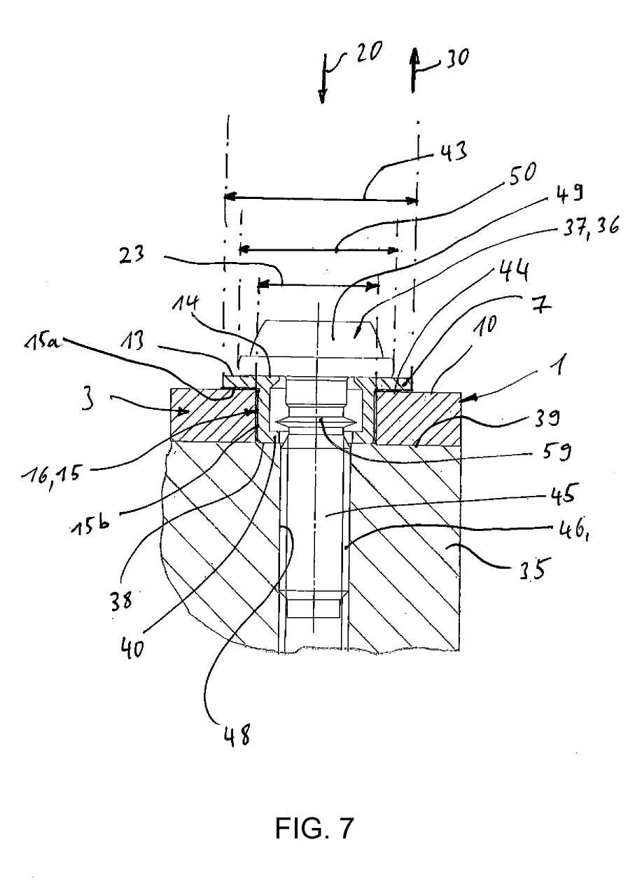

FIGS. 6, 7 show depictions which illustrate the production of an assembly unit with the aid of the fastener unit from FIG. 4,

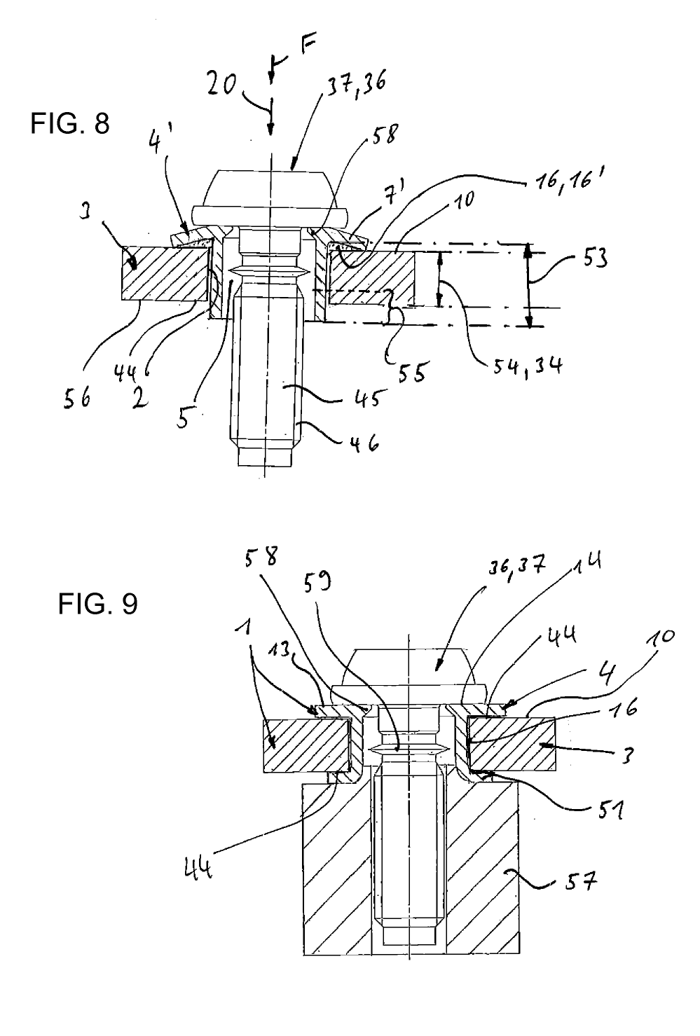

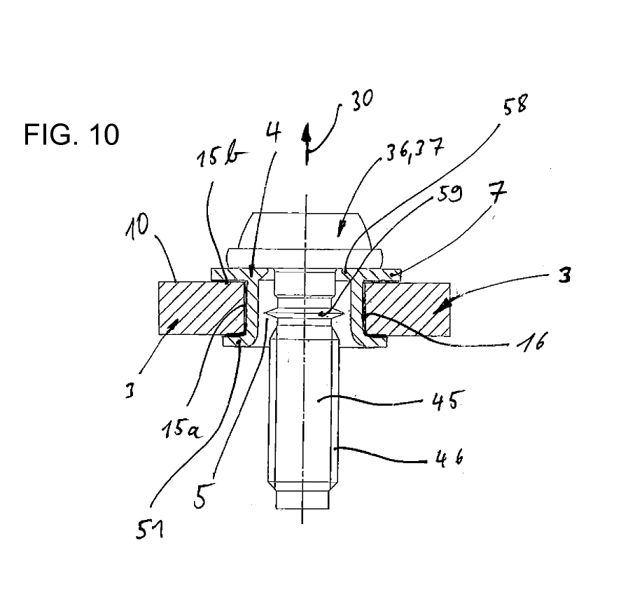

FIGS. 8-10 show depictions which illustrate the production of an alternative assembly unit.

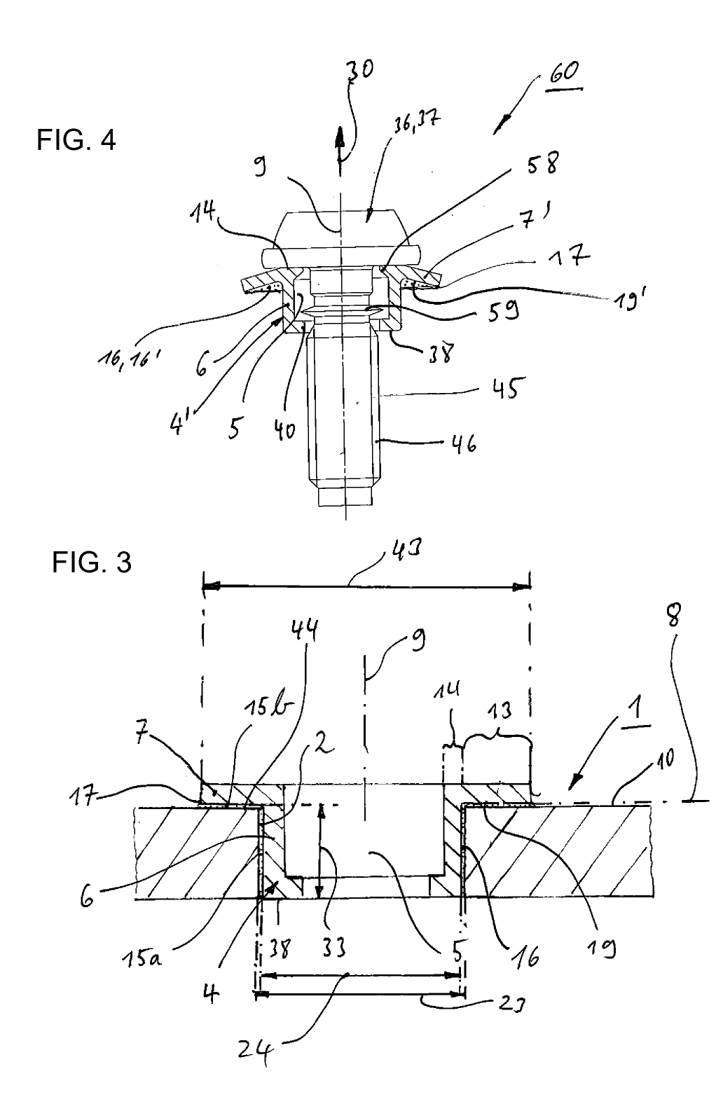

The aim of the method according to the invention is the production of an assembly unit 1 which comprises an assembly part 3 through which a bore 2 passes and at least one sleeve 4 (see for example FIG. 3). The sleeve 4 has a sleeve shaft 6 through which a through-opening 5 passes axially and a terminal flange 7 that overhangs the sleeve shaft 6 radially toward the outside. The flange 7 is preferably positioned such that its top side 13 is aligned with the flange-side end side 14 of the sleeve shaft 6. The sleeve shaft 6 is plugged into the bore 2 in the assembly part 3. In this case, the flange 7 extends as a whole in a plane 8 which extends at right angles to the longitudinal center axis 9 of the sleeve, or parallel to the outer side 10, facing the flange 7, of the assembly part 3. The flange 7 is oriented parallel to the outer side 10, facing said flange 7, of the assembly part 3. The joint 15 present between the flange 7 and the outer side 10 and between the sleeve shaft 6 and the wall 41 of the bore 2 is filled with an insulating compound 16. The latter serves very generally to seal the joint 15 and thus above all to prevent contact corrosion. Such corrosion occurs in particular when the assembly part 3 consists of CFRP and the sleeve 4 consists of a base metal or an alloy such as steel or aluminum.

In order to produce an assembly unit 1 of the described type, it would be conceivable to provide the surfaces of the sleeve 4 of the assembly part 3 that are in contact with one another with an insulating compound 16 before said parts are joined, although this would be associated with a very large amount of effort and the abovementioned problems. According to the invention, use is made of a sleeve blank 4′ which differs from the subsequent sleeve 4 of the assembly unit 1 in that its flange 7′ is in a preassembly form. In this form, the outer rim 17, assigned to the flange underside 19′, of the flange 7′ extends in a plane 8 extending at right angles to the longitudinal center axis 9 of the sleeve blank 4′, wherein, however, the flange underside 19′ adjoining the outer rim 17 radially toward the inside is hollowed out in a concave manner and carries an insulating compound store 16′. The latter covers the flange underside 19′ at least in part and optionally also in the upper region, or region close to the flange, of the sleeve shaft 6. The sleeve blank 4′ is inserted by way of its sleeve shaft 6 into the bore 2 in the assembly part 3 in an introduction direction 20. In this case, the flange 7′ bears only with its outer rim 17 on the outer side 10 of the assembly part 3. The size, or the radial dimension, of the joint portion 15a present between the wall of the bore 2 and the sleeve shaft 6 results from the difference between the diameter 23 of the cylindrical bore 2 and the slightly smaller outside diameter 24 of the likewise cylindrical sleeve shaft 6.

Proceeding from the situation shown in FIG. 2, a force F is applied to the sleeve blank 4′ in the introduction direction 20, wherein, to this end, a stamping tool (not shown) can be used. As a result of the application of force, the flange 7′ is plastically deformed and in the process the concavity of the remaining flange underside 19 is at least partially eliminated. In other words, the receiving space 26 bounded by the flange underside 19′, the outer rim 17, the outer side 10 of the assembly tool 3, and the circumferential surface 25 of the sleeve shaft 6 is reduced in size and in the process the insulating compound store 16′ present therein is displaced into the joint 15. The latter comprises the abovementioned joint portion 15a between the sleeve shaft 6 and the wall of the bore 2 and also a joint portion 15b between the flange 7 and the outer side 10 of the assembly part 3.

During said application of force, the outer rim 17 of the flange 7′ is pressed against the outer side 10 of the assembly part 3. This prevents insulating compound 16 from being able to be displaced radially toward the outside out of the receiving space 26, or the joint portion 15b formed therefrom, before the joint 15 has been completely filled with insulating compound 16. In the exemplary embodiments illustrated, the insulating compound store 16′ extends over the entire flange underside 19′ of the flange 7′ of the sleeve blank 4′, and so the joint portion 15b formed from the receiving space 26 is already filled with insulating compound 16. Furthermore, complete coating of the flange underside 19′ of the sleeve blank 4′ affords the advantage that the outer rim 17 does not bear directly on the outer side 10 of the assembly part, and so the risk of damage to the assembly part 3 or direct contact between the flange 7 and assembly part 3 does not occur or is at least reduced when the flange 7′ is plastically deformed.

In the depicted examples, the receiving space 26 is ensured with the aid of a conical flange 7′. In this case, the flange underside 19′ forms with the longitudinal center axis 9 of the sleeve blank 4′ an angle α that opens toward the flange-remote end 27 of the sleeve shaft 6.

The length 53 of the sleeve shaft 6 of the sleeve blank 4′ or of the sleeve 4 corresponds substantially to the thickness 34 of the assembly part 3 in the region of the bore rim 44, or to the length 54 of the bore 2. If the assembly part 3, or the assembly unit 1, is intended to be fixed to a component 35 with the aid of a fastener 37 preferably in the form of a bolt 36, the sleeve 4 bears with its flange-remote end side 38 against the component 35 or against an assembly surface 39 present thereon (see FIG. 7). The pretensioning force exerted by the fastener is in this case introduced into the component 35 in the main force fit via the sleeve. In order to reduce the surface pressure, it is expedient for the sleeve 4 to have an annular protrusion 40 that extends radially toward the inside and is aligned with the flange-remote end side 38. The clamping of the assembly part 3 with the component 35 takes place in the secondary force fit via the flange 7 of the sleeve. The diameter 43 of said flange 7 is greater than the diameter 23 of the bore 2 in the assembly part 3. The flange 7 thus overlaps the outer side 10 of the assembly part, or the external bore rim 44.

The fastener 37 has a shank 45 which carries a fixing portion 46 at its one end, said fixing portion 46 being in the form of a thread in the case of a bolt (see FIG. 5). The fixing portion 46 engages in a counterbore 48 in the component 35, this being a threaded bore in the case of a bolt. Integrally formed on the shank 45 at its end opposite the fixing portion 46 is a head 49 that radially overhangs the shank 45. The maximum diameter 50 of said shank 45 is greater than the diameter 23 of the bore 2. The head 49 thus at least partially overlaps the flange 7 of the sleeve 4 and the external bore rim 44 of the assembly part 3.

The insulating compound 16 introduced into the joint 15 can, in addition to its insulating property, also serve to fix the sleeve 4 in the bore 2. In this case, the insulating compound 16 is an adhesive. Preferably, use is made of a microencapsulated adhesive which contains two differently filled microcapsules, namely those which contain a crosslinkable polymer and those which contain a curing agent that brings about the crosslinking of the polymer. During the deformation of the flange 7′ of the sleeve blank 4′ and while the sleeve shaft 6 is pushed into the bore 2 of the assembly part 3, the microcapsules are destroyed as a result of compressive and shear forces, and so said components are released and the insulating compound cures. It is thus possible to prefabricate assembly units 1 in the bores 2 of which sleeves 4 have already been fixed at least with such a firmness that the assembly units 1 can be transported and handled without the sleeves 4 being lost.

Rather than with an adhesive as insulating compound 16 or in addition thereto, the sleeve 4 can be fixed to the assembly part 3 by use being made of a sleeve blank 4′ of which the sleeve shaft 6 has a length 53 greater than the thickness 34 in the region of the bore rim 44, or than the length 54 of the bore 2 (FIG. 8). In the assembled state, an end portion 55 of the sleeve blank 4′ would thus protrude out of the assembly side 56, opposite the outer side 10, of the assembly part. However, with the aid of a stamping tool 57, the end portion 55 is plastically deformed radially toward the outside such that it forms a flange 51 radially overlapping the assembly-side bore rim 44. In the present case, the joint 15 has a further joint portion 15c, which is located between the flange 51 and the assembly-side bore rim 44. The insulating compound store 16′ is of such a size that insulating compound 16 is also displaced into the joint portion 15c.

If an assembly unit 1 that is already equipped both with a sleeve 4 and with a fastener 37 is intended to be produced, the use of a fastener unit 60 which consists of a sleeve blank 4′ of the above-described type and a fastener 37 is advantageous, wherein the fastener 37 engages through the sleeve blank 4′, or the through-opening 5 therein, with its shank 45. The fastener 37 is captively connected to the sleeve blank 4′ in that a rear-engagement element 58 is integrally formed on the flange-side end of the sleeve blank 4′, said rear-engagement element 58 extending radially toward the inside and radially overlapping a retaining element 59 that protrudes radially toward the outside from the shank 45 on its side facing the head 49.

The fastener unit 60 is plugged into the bore 2 in the assembly part 3 and subsequently the plastic deformation of the flange 7′ of the sleeve blank 4′ is carried out by application of force in the introduction direction 20. In this case, as is the case in the examples according to FIGS. 6 and 8 to 10, a force F in the introduction direction is applied to the head 49 of the fastener 37.

In another method variant, the assembly unit 1 is formed only during the fixing of an assembly part 3 to a component 35. In this case, the force F to be applied to the sleeve blank 4′ in the introduction direction is generated with the aid of the fastener 37 in that the latter is fixed with its fixing portion 46 in the counterbore 48 in the component 35. On account of the pretensioning force of the fastener 37 that builds up in the process, the head 49 of said fastener 37 is pressed in the introduction direction 20 against the sleeve blank 4′ and the flange 7′ thereof is pressed against the outer side 10 of the assembly part 3 with plastic deformation.

List of reference signs

| | |
|---|---|
| 1 | Assembly unit |
| 2 | Bore |
| 3 | Assembly part |
| 4 | Sleeve |
| 4′ | Sleeve blank |
| 5 | Through-opening |
| 6 | Sleeve shaft |
| 7 | Flange |
| 8 | Plane |
| 9 | Longitudinal center axis (of 4) |
| 10 | Outer side (of 3) |
| 13 | Top side (of 7) |
| 14 | End side (flange-side of 4) |
| 15 | Joint |
| 16 | Insulating compound |
| 16′ | Store of insulating compound |
| 17 | Outer rim |
| 19 | Flange underside |
| 20 | Introduction direction |
| 23 | Diameter (of 2) |
| 24 | Outside diameter (of 6) |
| 25 | Circumferential surface (of 6) |
| 26 | Receiving space |
| 27 | Flange-remote end (of 6) |
| 30 | Direction |
| 33 | Length |
| 34 | Thickness (of 3) |
| 35 | Component |
| 36 | Bolt |
| 37 | Fastener |
| 38 | Flange-remote end side |
| 39 | Assembly surface |
| 40 | Annular protrusion |
| 41 | Wall (of 2) |
| 43 | Diameter (of 7) |
| 44 | Bore rim |
| 45 | Shank (of 37) |
| 46 | Fixing portion |
| 48 | Counterbore |
| 49 | Head |
| 50 | Diameter (of 49) |
| 51 | Flange |
| 53 | Length (of 6) |
| 54 | Length (of 2) |
| 55 | End portion |
| 56 | Assembly side (of 3) |
| 57 | Stamping tool |
| 58 | Rear-engagement element |
| 59 | Retaining element |
| 60 | Fastener unit |

1-14. (canceled)

15. A method for producing an assembly unit containing an assembly part having a bore formed therein and a sleeve having a sleeve shaft with a through-opening passing there-through, the sleeve further having a terminal flange overhanging the sleeve shaft radially toward an outer side, the sleeve shaft being plugged into the bore, the terminal flange being oriented parallel to an outer side, facing the terminal flange, of the assembly part, and a gap formed between the terminal flange and the outer side of the assembly part and a gap formed between the sleeve shaft and a wall defining the bore being filled with an insulating compound, which method comprises the steps of:
providing a sleeve blank having the terminal flange and the sleeve shaft, the terminal flange of the sleeve bank having a preassembly form such that an outer rim, assigned to a flange underside, of the terminal flange extends in a plane that extends at right angles to a longitudinal center axis of the sleeve shaft such that the flange underside is concave resulting in a concaved flange underside;
plugging the sleeve shaft into the bore in an introduction direction such that the outer rim of the terminal flange rests against the outer side of the assembly part; and
disposing a store of a flowable insulating compound in a receiving space present between the terminal flange and the outer side of the assembly part on account of the concaved flange underside, and as a result of a force being applied to the sleeve blank in the introduction direction, the terminal flange being pressed against the outer side of the assembly part with plastic deformation and at least partial elimination of a concavity of the flange underside, or a reduction in size of the receiving space, resulting in the flowable insulating compound in the store being displaced into the gap present between the sleeve and the assembly part.

16. The method according to claim 15, wherein the store adheres to the concaved flange underside of the sleeve.

17. The method according to claim 16, wherein the terminal flange of the sleeve is a conical flange having the flange underside which forms with the longitudinal center axis of the sleeve shaft an angle that opens toward a flange-remote end of the sleeve shaft.

18. The method according to claim 16, wherein the store of the flowable insulating compound extends radially toward an outside to such an extent that store covers the outer rim.

19. The method according to claim 15, which further comprises selecting a microencapsulated adhesive as the flowable insulating compound.

20. The method according to claim 19, wherein the microencapsulated adhesive contains microcapsules which are filled with a cross-linkable polymer and the microcapsules are filled with a curing agent that brings about a cross-linking of the cross-linkable polymer.

21. The method according to claim 15, which further comprises equipping the sleeve blank with a fastener containing a shank having a fixing portion that engages through the through-opening in the sleeve blank, the fastener further having a head that is integrally formed on a shank end disposed opposite the fixing portion and radially overhangs the shank, a diameter of the head being greater than a diameter of the bore in the assembly part.

22. The method according to claim 21, which further comprises connecting the fastener captively to the sleeve blank with a form fit in a direction pointing away from the outer side of the assembly part and/or from a flange-side end side of the sleeve shaft.

23. The method according to claim 22, wherein in order to produce the form fit, integrally forming a rear-engagement element in a region of a flange-side end side of the sleeve blank, the rear-engagement element extending radially toward an inside and radially overlapping a retaining element that protrudes radially toward an outside from the shank.

24. The method according to claim 21, wherein the application to the sleeve blank of the force in the introduction direction for the purpose of the plastic deformation of the sleeve blank takes place with an aid of a fastener head.

25. The method according to claim 24, which further comprises performing the plastic deformation of the terminal flange during a fixing of the assembly part to a component with the aid of the fastener, wherein the fixing portion of the shank is connected to a counterbore in the component and in the process the head of the fastener acts on the sleeve blank in the introduction direction.

26. The method according to claim 15, which further comprises providing the sleeve blank having the sleeve shaft with a length being greater than a length of the bore, wherein an end portion, corresponding to a difference in length, of the sleeve shaft is plastically deformed radially toward the outside such that the end portion forms a flange which overlaps a bore rim assigned to a mounting side.

27. A fastener unit, comprising:
a sleeve blank including:
a sleeve shaft with a through-opening formed therein and passing through said sleeve shaft;
a terminal flange overhanging said sleeve shaft radially toward an outside and having a flange underside, said terminal flange having a preassembly form such that an outer rim, assigned to said flange underside, of said terminal flange extends in a plane that extends at right angles to a longitudinal center axis of said sleeve shaft such that said flange underside is concave;
a store of a flowable insulating compound adhering to said flange underside; and
a fastener connected captively to said sleeve blank with a form fit in a direction pointing away from a flange-side end side of said sleeve shaft, said fastener having a shank with a fixing portion and engaging through said through-opening in said sleeve blank, a head integrally formed on a shank end disposed opposite said fixing portion and radially overhanging said shank, said head having a diameter being greater than a diameter of said bore in said assembly part.

28. The fastener unit according to claim 27, further comprising:
a retaining element; and
a rear-engagement element integrally formed in a region of said flange-side end side of said sleeve blank, said rear-engagement element extending radially toward an inside and radially overlapping said retaining element that protrudes radially toward the outside from said shank on a side thereof that faces said head.
